(19) United States
(12) Patent Application Publication
(10) Pub. No.: US 2005/0061756 A1
(43) Pub. Date: Mar. 24, 2005

(54) Peg hook loader and method for its use

(76) Inventor: Henry Mattesky, Ramsey, NJ (US)

Correspondence Address: John K. Kim;McCarter & English, LLP, Four Gateway Center, 100 Mulberry Street, Newark, NJ, 07102, US

(21) Appl. No.: 10/903,506

(22) Filed: Jul. 30, 2004

Related U.S. Application Data
(60) Provisional application No. 60/492,128, filed on Aug. 1, 2003.

(51) Int. Cl. B42F 1/00

(52) U.S. Cl. 211/59.1; 211/57.1

(57) ABSTRACT

The present invention relates to a device for holding and facilitating the unloading therefrom of packaged merchandise onto a display peg. More particularly, the device includes a substantially rigid member for holding a group of packages together. The member has opposing ends and is sized and shaped so as to pass through hanging holes provided in the packages. The member also has a generally uniform cross-section along its entire axial length and includes an opening extending through the member between the opposing ends. The opening is provided with a size which is substantially greater than a cross-sectional area of the display peg so as to facilitate the insertion of the display peg into the opening through one of the opposing ends for permitting the packages to be placed onto the display peg with the aid of the member. The present invention also relates to a method for loading the packages onto the display peg using the device.

### CROSS-REFERENCE TO RELATED APPLICATION

This application claims the benefit of U.S. Provisional Patent Application No. 60/492,128 filed Aug. 1, 2003.

### FIELD OF THE INVENTION

The present invention relates to devices for displaying packaged merchandise and, more particularly, to devices for loading packaged merchandise onto pegboard displays.

### BACKGROUND OF THE INVENTION

Pegboard displays have been popular in the retail industry for displaying lightweight merchandise. Typically, merchandise packages are loaded individually onto pegboard displays. As a result, the conventional loading method is inefficient and time-consuming. Given the narrow profit margin on which most retail outlets operate, cost saving in this activity is desirable.

A recent solution to the problem mentioned above has been the “power panel”. The “power panel” is a ready made package of a number of loaded pegs in a box, which is simply hung up on a shelf wall. This displaying method has disadvantages in that it is expensive and does not provide means of recharge if there is a substantial difference in the sale of different items in the panel.

Various devices have also been developed for facilitating the loading of merchandise onto a display peg. For instance, U.S. Pat. No. 4,143,772 discloses a device having a plug which connects by a cord through a rear hole of a cup-shaped coupler. The plug and coupler can be joined together to form a loop that holds merchandise. The coupler can be separated from the plug and connected to the end of a display peg, so that the merchandise can slide onto the peg. Because the device needs to be uncoupled prior to the loading of the merchandise onto a display peg, the merchandise loading process is made rather complicated and/or inefficient.

### SUMMARY OF THE INVENTION

The present invention overcomes the disadvantages and shortcomings of the prior art discussed above by providing a new and improved device for holding and facilitating the unloading therefrom of packaged merchandise onto a display peg. More particularly, the device includes a substantially rigid member for holding a group of packages together. The member has opposing ends and is sized and shaped so as to pass through hanging holes provided in the packages. The member also has a generally uniform cross-section substantially along its entire axial length and includes an opening extending through the member between the opposing ends. The opening is provided with a size which is substantially greater than a cross-sectional area of the display peg so as to facilitate the insertion of the display peg into the opening through one of the opposing ends for permitting the packages to be placed onto the display peg with the aid of the member.

The present invention also relates to a method for loading packaged merchandise onto a display peg using a loading device having a substantially rigid member. More particularly, the member includes opposing ends, as well as generally uniform cross-section substantially along its entire length. The member has an opening extending through the member between the opposing ends. The opening of the member has a size which is substantially greater than a cross-sectional area of the display peg so as to facilitate the insertion of the display peg into the opening. The method includes the steps of passing the member through hanging holes provided in packages and inserting the display peg into the opening of the member through one of the opposing ends such that the display peg passes through the hanging holes of the packages. The member is then removed from the hanging holes of the packages such that the packages are loaded onto the display peg.

### BRIEF DESCRIPTION OF THE DRAWINGS

For a more complete understanding of the present invention, reference is made to the following detailed description of the present invention considered in conjunction with the accompanying drawings, in which:

FIG. 1 is a schematic view of a peg hook loader according to the present invention which has been installed with packaged merchandise;

FIG. 2 is a detailed perspective view of the peg hook loader of FIG. 1;

FIG. 3 is a cross-sectional view of the peg hook loader of FIG. 1;

FIG. 4 is a schematic view of the peg hook loader of FIG. 1 prior to mounting the peg hook loader onto a common peg hook;

FIG. 5 is a schematic view of the peg hook loader of FIG. 1 which has been mounted on a peg hook with the packaged merchandise;

FIG. 6 is a schematic view of the peg hook loader of FIG. 1 which has been removed from the product, leaving the packaged merchandise mounted on the peg hook; and

FIG. 7 is a schematic view of a second peg hook loader according to the present invention.

### DETAILED DESCRIPTION OF THE INVENTION

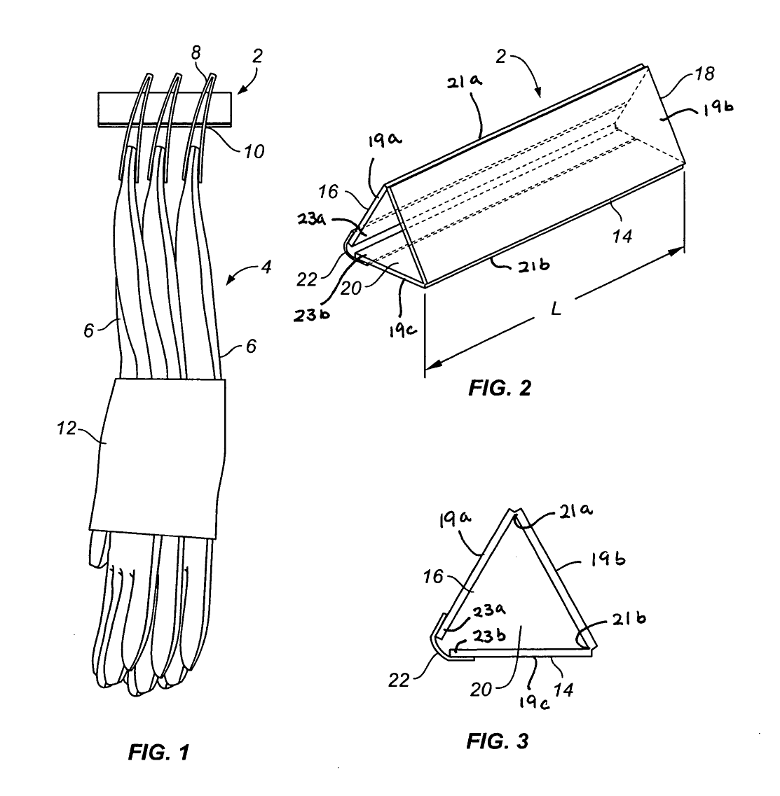

FIG. 1 illustrates a peg hook loader 2 according to the present invention that has been installed within a bundle 4 of products or packages 6 (i.e. packaged merchandise). Each product 6 is provided with a cardboard header tag 8 having a triangular opening (i.e., hanging hole) 10 therein. Other products 6 may be provided with hooks (not shown) to hang the products 6. The products 6 are secured for transport within the bundle 4 by a paper tape 12 that is wrapped around the bundle 4.

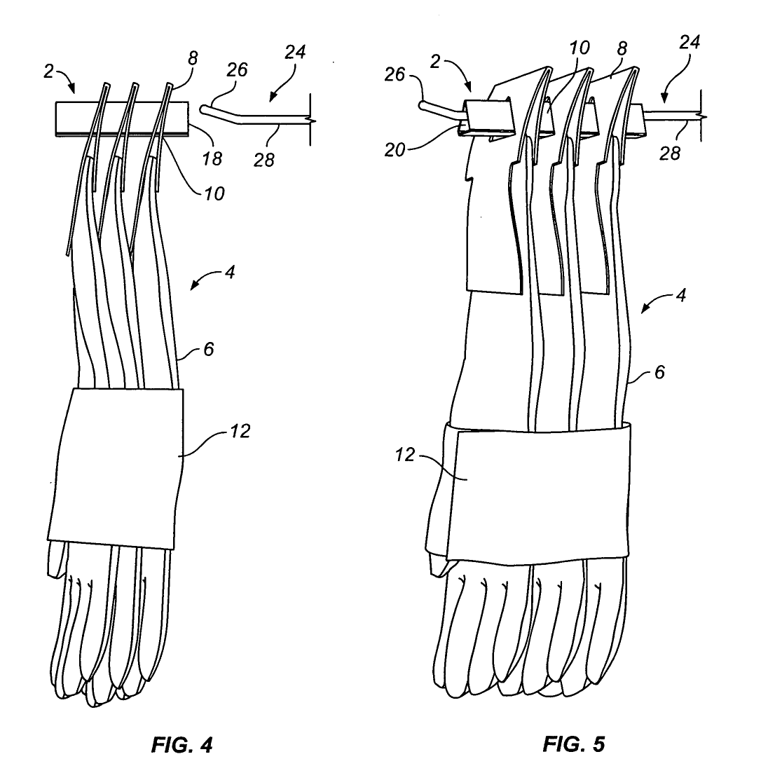

FIGS. 2 and 3 provide views of the peg hook loader 2 in more detail. The peg hook loader 2 has a hollow member 14 with opposing open ends 16 and 18 and an open interior (i.e., an opening) 20. Preferably, the hollow member 14 is sufficiently structured to support a product or bundle of products as the products are being placed on a peg with the peg hook loader 2. The hollow member 14 is formed from a sheet of thin corrugated material that has been scored and folded so as to have a substantially uniform triangular cross-section (see FIG. 3). A reinforcing strip 22 closes the hollow member 14 along one edge, providing the hollow member 14 with a closed cross-section, and provides additional structural strength to the hollow member 14. The size of the hollow member 14 depends on design of the product 6 or product bundle 4 with which it is to be used. The outside dimensions of the cross-section are selected so that the hollow member 14 may be inserted through an opening or hook of the product which may then hang from the peg hook loader 2 (see FIG. 1). The inside dimensions of the open ends 16 and 18 and the open interior 20 are selected so that the hollow member 14 may fit over a typical peg hook. The hollow member 14 has a length L which, preferably, is sufficient to pass through the openings or hooks of two or more products 6. For instance, the open interior 20 of the hollow member 14 can have a size much greater than the cross-sectional area of a display peg hook so as to facilitate the insertion of same into the open interior 20. Moreover, the hollow member 14 can be constructed such that its cross-section corresponds substantially, in shape and size, to the opening 10 of the package 6.

Still referring to FIGS. 2 and 3, the hollow member 14 includes a plurality of substantially planar panels 19a-19c and a pair of fold lines 21a, 21b which extend along in a generally axial direction. More particularly, the fold line 21a is formed between the panels 19a, 19b, while the fold line 21b is formed between the panels 19b, 19c. The panels 19a, 19c include edges 23a, 23b, respectively, which are juxtaposed with one another such that the cross-section of the hollow member 14 is substantially triangular.

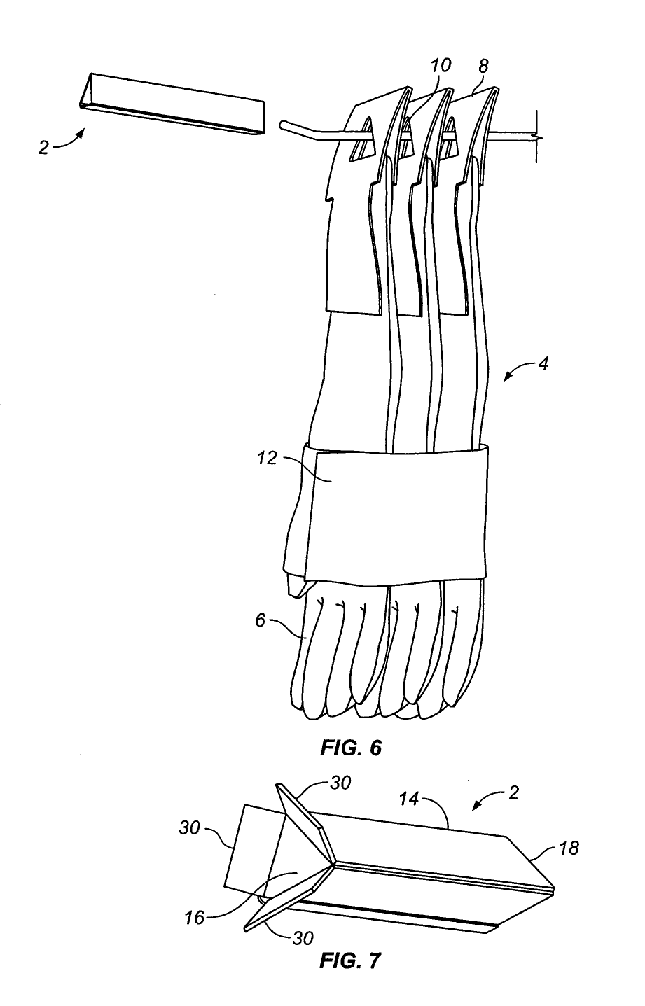

FIGS. 4-6 illustrate a preferred method of using the peg hook loader 2 to transfer the bundle 4 of products 6 to a peg hook 24. Referring now to FIG. 4, the peg hook loader 2 is again shown installed within the bundle 4. The peg hook 24 is a common peg hook typical of retail display devices. The peg hook loader 2, with the associated bundle 4 is then placed over the peg hook tip 26 and slid along the body 28 of the peg hook 24. FIG. 5 shows the peg hooker loader 2 mounted on the peg hook 24 with the open interior 20 of the peg hook loader 2 surrounding the body 28 of the peg hook 24. The peg hook loader 2 is then slid out of the openings 10 of the bundle 4, leaving the bundle 4 of products 6 on the peg hook 24. The products 6 can then be separated from each other by removing the paper tape 12. As shown, the method of FIGS. 4-6 provides a very simple way of transferring a product onto a retail display in numbers of 2-12 or greater, depending on the length L of the peg hook loader 2.

It should be appreciated that the present invention provides numerous advantages over the prior art discussed above. For instance, because the bundle 4 of products 6 is gathered together as a single assembly (i.e., triangular opening 10 of the products 6 are aligned and ganged together via paper tape 12) and then shipped to a retail outlet, loading of the bundle 4 onto the peg hook 24 can be achieved in a simple and efficient manner. That is, the peg hook tip 26 of the peg hook 24 is aligned with the triangular opening 10 of the products 6 and is then inserted therethrough in a substantially single motion or step. Moreover, because only the peg hook loader 2 is used for quick and easy loading of the products 6, the present invention provides a cost-effective loading method.

It should be noted that the present invention can have numerous modifications and variations. For example, the hollow member 14 may be of a flexible or semi-rigid construction, rather than being rigid. The hollow member 14 may be fabricated from a wide range of materials that will be known to persons having ordinary skill in the art, such at plastics, paperboard, thin metal sheet, and so forth. It also is not necessary for the hollow member 14 to have a triangular cross-section as shown in FIG. 2, but may have a cross-section having another shape, such as a circle or trapezoid, depending on the shape of the openings 10 of the bundled product 4. The reinforcing strip 22 may be omitted or additional reinforcing strips may be provided as needed to provide structural support to the peg hook loader 2. Moreover, the cross-section of the hollow member 14 does not need to have a closed shape, but may have an open shape such as a half circle, an arc or an inverted “V”, depending on the shape of the openings 10 and the amount of support needed to support and stabilize the individual products 6 within the bundle 4. The products 6 may be secured within the bundle 4 by any of a number of known devices, such as plastic end caps or plastic tape with a light tack adhesive. Further, the peg hook loader 2 can be used in connection with many different types of packages or items, such as polybags, paper or cardboard headers or boxes.

FIG. 7 presents another embodiment of the peg hook loader 2 wherein the hollow member 14 has been flared at open end 16. A flare such as flare 30 serves to prevent the peg hook loader 2 from becoming disengaged from the bundle 4 during shipping. In the embodiment of FIG. 7, the flare 30 was formed by folding the thin corrugated material of the hollow member 14 back upon itself such that it is monolithic with the hollow member 14. The flare 30 can be easily straightened by applying a slight pressure to it, allowing the peg hook loader 2 to be removed from the bundle 4. That is, the flare 30 can be movably affixed to one of the ends 16, 18 of the hollow member 14. In other embodiments, both open ends 16 and 18 may be flared. The hollow member 14 may be fabricated, and its ends 16 and 18 may be flared, by any of a number of methods currently known in the art.

Although the invention disclosed herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims.

1. A device for holding and facilitating the unloading therefrom of packaged merchandise onto a display peg, comprising a substantially rigid member for holding a group of packages together, said member having opposing ends and being sized and shaped so as to pass through hanging holes provided in the packages, said member having a generally uniform cross-section substantially along its entire axial length, said member having an opening extending through said member between said opposing ends, said opening having a size which is substantially greater than a cross-sectional area of the display peg so as to facilitate the insertion of the display peg into said opening through one of said opposing ends for permitting the packages to be placed onto the display peg with the aid of said member.

2. A device according to claim 1, wherein said cross-section of said member corresponds substantially, in shape and size, to the hanging holes of the packages.

3. A device according to claim 2, wherein said member includes at least one substantially planar panel extending in a generally axial direction.

4. A device according to claim 3, wherein said member is formed from a sheet of material folded into a predetermined shape.

5. A device according to claim 4, wherein said member includes a fold line extending in said axial direction.

6. A device according to claim 5, wherein said at least one planar panel includes first and second panels, said fold line being formed between said first and second panels.

7. A device according to claim 6, wherein said at least one planar panel includes a third panel, said member including a second fold line formed between said second and third panels.

8. A device according to claim 7, wherein said first panel includes an edge; and wherein said third panel includes an edge, said edges of said first and third panels being juxtaposed with one another such that said cross-section of said member is substantially triangular.

9. A device according to claim 8, further comprising a reinforcing strip for reinforcing said member.

10. A device according to claim 9, wherein said reinforcing strip is affixed to said member for attaching said edge of said first panel to said edge of said third panel.

11. A device according to claim 1, further comprising retaining means for retaining the packages on said member.

12. A device according to claim 11, wherein said retaining means includes at least one flare projecting outwardly from one of said opposing ends of said member.

13. A device according to claim 12, wherein said at least one flare includes a plurality of flares projecting from said one of said opposing ends of said member.

14. A device according to claim 13, wherein each of said plurality of flares is movably affixed to said one of said opposing ends of said member.

15. A device according to claim 14, wherein each of said plurality of flares is monolithically formed with said member.

16. A method for loading packaged merchandise onto a display peg using a loading device having a substantially rigid member, the member including opposing ends and having a generally uniform cross-section substantially along its entire axial length, the member having an opening extending through the member between the opposing ends, the opening of the member having a size which is substantially greater than a cross-sectional area of the display peg so as to facilitate the insertion of the display peg into the opening, the method comprising the steps of passing the member through the hanging holes of the packages; inserting the display peg into the opening of the member through one of the opposing ends such that the display peg passes through the hanging holes of the packages; and removing the member from the hanging holes of the packages such that the packages are loaded onto the display peg.

17. A method according to claim 16, wherein the cross-section of the member corresponds substantially, in shape and size, to the hanging holes of the packages.

18. A method according to claim 17, wherein the member includes at least one substantially planar panel extending in a generally axial direction.

19. A method according to claim 18, wherein the member is formed from a sheet of material folded into a predetermined shape.

20. A method according to claim 19, wherein the planar panel includes first, second and third panels, said member including a first fold line, which is formed between the first and second panels, and a second fold line, which is formed between the second and third panels, the first panel including an edge, the third panel including an edge, the edges of the first and third panels being juxtaposed with one another such that the cross-section of the member is substantially triangular.
